(19) United States
(12) Patent Application Publication
(10) Pub. No.: US 2018/0267454 A1
(43) Pub. Date: Sep. 20, 2018

(54) IMAGE FORMING APPARATUS

(71) Applicant: KYOCERA Document Solutions Inc., Osaka (JP)

(72) Inventor: Koji Uno, Osaka (JP)

(21) Appl. No.: 15/920,040

(22) Filed: Mar. 13, 2018

(30) Foreign Application Priority Data
Mar. 15, 2017 (JP) 2017-049752

(51) Int. Cl. G03G 15/00; B65H 5/38

(52) U.S. Cl. CPC G03G 15/657; G03G 2215/00413; B65H 5/38

(57) ABSTRACT

An image forming apparatus includes a fixing portion, a conveyance path, and an electricity removing portion. The conveyance path has a guide surface configured to guide a sheet with a toner image transferred thereto, to the fixing portion. The electricity removing portion includes a conductive member and an operation member. The conductive member removes charges from the sheet guided by the guide surface. The operation member changes a relative position of the conductive member with respect to the guide surface and adjusts a distance of the conductive member with respect to the sheet guided by the guide surface.

### INCORPORATION BY REFERENCE

This application is based upon and claims the benefit of priority from the corresponding Japanese Patent Application No. 2017-049752 filed on Mar. 15, 2017, the entire contents of which are incorporated herein by reference.

### BACKGROUND

The present disclosure relates to an image forming apparatus.

In an image forming apparatus of an electrophotographic system, a toner image carried by an image carrier is transferred to a sheet by a transfer roller, and then the toner image is fixed to the sheet by a fixing device. In this type of image forming apparatus, transfer charges are applied to the sheet when the toner image is transferred from the image carrier to the sheet, and due to the transfer charges, a conveyance failure such as a paper jam may occur when the sheet is conveyed to the fixing divice. The conveyance failure leads to a malfunction such as generation of wrinkles on the sheet when the fixing device fixes the toner image to the sheet. There is known an image forming apparatus in which, in order to restrict the conveyance failure, an electricity removing device is disposed at a conveyance path between the transfer roller and the fixing device.

### SUMMARY

An image forming apparatus according to an aspect of the present disclosure includes an image carrier, a transfer portion, a fixing portion, a conveyance path, and an electricity removing portion. The image carrier carries a toner image. The transfer portion transfers the toner image carried by the image carrier to a sheet. The fixing portion fixes, to the sheet, the toner image transferred to the sheet. The conveyance path has a guide surface configured to guide the sheet with the toner image transferred thereto, to the fixing portion. The electricity removing portion includes a conductive member and an operation member. The conductive member removes charges from the sheet guided by the guide surface. The operation member changes a relative position of the conductive member with respect to the guide surface and adjusts a distance of the conductive member with respect to the sheet guided by the guide surface.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram of an image forming apparatus according to a first embodiment of the present disclosure.

FIG. 2 is a front diagram showing an electricity removing device of the image forming apparatus shown in FIG. 1.

FIG. 3 is a cross-sectional diagram taken along a cut line shown in FIG. 2.

FIG. 4 is a cross-sectional diagram taken along a cut line IV-IV shown in FIG. 2.

FIG. 5 is a cross-sectional diagram taken along a cut line V-V shown in FIG. 2.

FIG. 6 is a cross-sectional diagram of the electricity removing device and its periphery for explaining an action of the electricity removing device.

FIG. 7 is a cross-sectional diagram of the electricity removing device and its periphery for explaining an action of the electricity removing device.

FIG. 8 is a cross-sectional diagram showing a cover member when an opening of an apparatus main body of the image forming apparatus shown in FIG. 1 is opened.

FIG. 9 is a cross-sectional diagram in which a main part of FIG. 8 is enlarged.

FIG. 10 is a front diagram showing an electricity removing device of an image forming apparatus according to a second embodiment of the present disclosure.

FIG. 11 is a cross-sectional diagram taken along a cut line XI-XI shown in FIG. 10.

FIG. 12 is a cross-sectional diagram taken along a cut line XII-XII shown in FIG. 10.

FIG. 13 is a front diagram showing a main part of the electricity removing device shown in FIG. 10.

### DETAILED DESCRIPTION

The following describes embodiments of the present disclusure with reference to the accompanying drawings. It should be noted that the following embodiments are examples of specific embodiments of the present disclosure and can be modified as necessary in a range where the gist of the present disclosure is not changed.

### First Embodiment

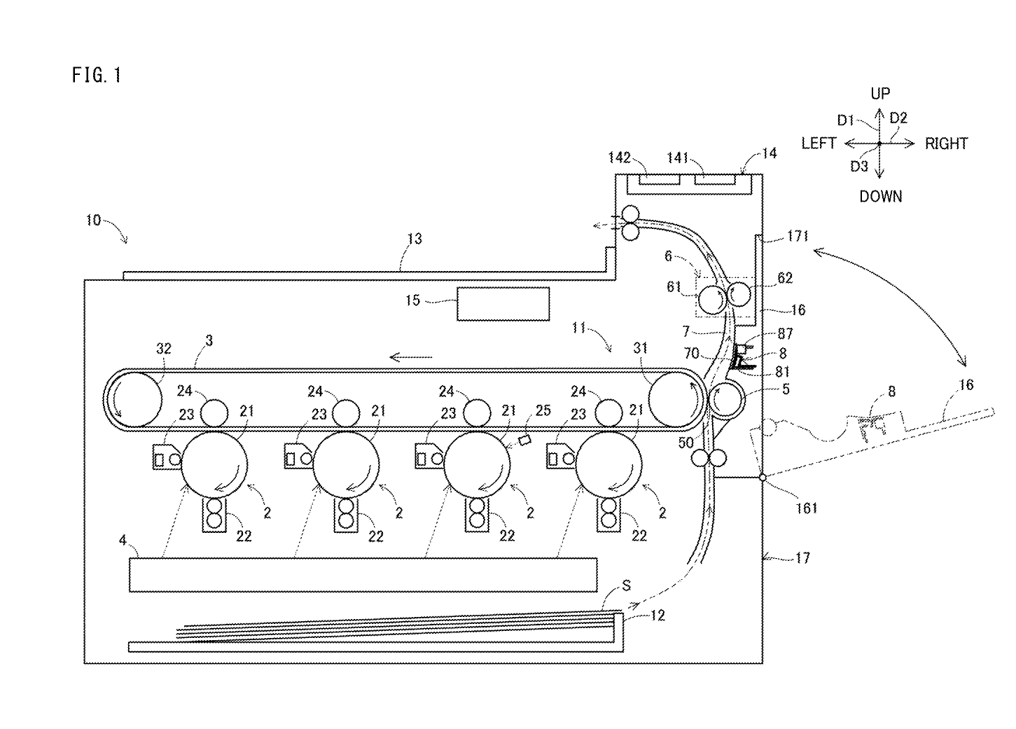

First, a description is given of an image forming apparatus 10 according to a first embodiment of the present disclosure with reference to FIG. 1 to FIG. 9. It is noted that for the sake of explanation, an up-down direction D1, a left-right direction D2, and a front-rear direction D3 are defined based on the state shown in FIG. 1.

The image forming apparatus 10 shown in FIG. 1 is a printer for forming a color image on a sheet S by an electrophotographic system by using developer including toner. It is noted that the present disclosure is applicable to a monochrome printer, a copier, a facsimile, and a multifunction peripheral, other than a color printer.

The image forming apparatus 10 includes an image forming portion 11, a sheet feed tray 12, a sheet discharge tray 13, an operation/display portion 14, a control portion 15, a conveyance path 7, an electricity removing device 8 (an example of the electricity removing portion of the present disclosure), and a cover member 16.

The image forming portion 11 includes a plurality of image forming units 2, an intermediate transfer belt 3 (an example of the image carrier of the present disclosure), an exposure device 4, a secondary transfer roller 5 (an example of the transfer portion of the present disclosure), and a fixing device 6 (an example of the fixing portion of the present disclosure).

Each of the image forming units 2 includes a photoconductor drum 21, a charging device 22, a developing device 23, and a primary transfer member 24.

The photoconductor drum 21 carries a toner image. The charging device 22 charges the outer circumferential surface of the photoconductor drum 21. The developing device 23 forms a toner image on the photoconductor drum 21. The primary transfer member 24 transfers the toner image from the photoconductor drum 21 to the intermediate transfer belt 3.

The intermediate transfer belt 3 carries a color toner image that is formed from toner images of a plurality of (in the present embodiment, four) colors. The intermediate transfer belt 3 is supported by a driving roller 31 and a driven roller 32 so as to be rotatably driven by them. It is noted that the driving roller 31 and the driven roller 32 may be reversed in position.

The exposure device 4 is configured to irradiate light on the surfaces of the photoconductor drums 21 so as to form electrostatic latent images on the surfaces of the photoconductor drums 21 based on the image data.

The conveyance unit 5 transfers the toner image carried by the intermediate transfer belt 3, to the sheet S conveyed from the sheet feed tray 12. The sheet S with the toner image transferred thereto is conveyed to the fixing device 6 along the conveyance path 7.

The fixing device 6 includes a heating roller 61 and a pressure roller 62. The fixing device 6 causes the heating roller 61 and the pressure roller 62 to apply heat and pressure to the sheet S with the color toner image transferred thereto, while conveying the sheet S. This allows the toner image to be fused and fixed to the sheet S. The sheet S with the toner image thus fixed is further conveyed to the downstream side, and discharged to the sheet discharge tray 13 that is disposed above the intermediate transfer belt 3.

The operation/display portion 14 includes an operation portion 141 and a display portion 142. The operation portion 141 is operated by the user when the user inputs information to the image forming apparatus 10, and includes a plurality of operation keys such as hard keys. The display portion 142 displays various types of information. The display portion 142 displays, for example, a notification that a conveyance route of the sheet S moving along the conveyance path 7 described below is shifted from a target conveyance route R by more than a predetermined distance. The display portion 142 is, for example, a liquid crystal display. The display portion 142 may be provided with a touch panel. In addition, the touch panel may constitute the operation portion 141. When the touch panel functions as the operation portion 141, the hard key and the like may be omitted.

The control portion 15 comprehensively controls the image forming units 2. The control portion 15 is, for example, a micro computer that includes a CPU, a ROM, a RAM and the like. In addition, the control portion 15 controls a distance measuring sensor 87 that is described below.

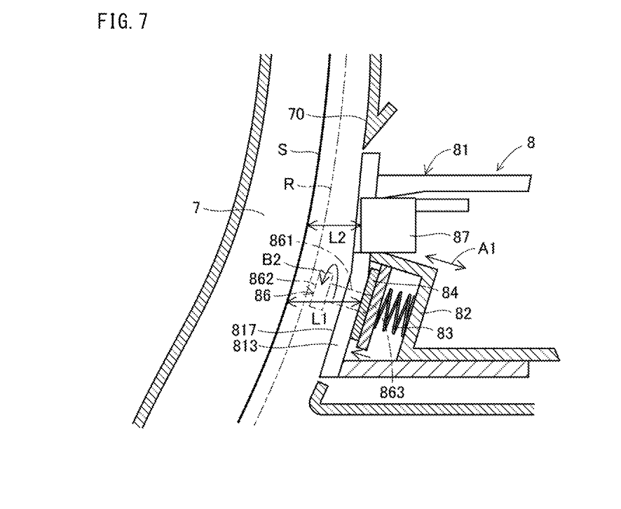

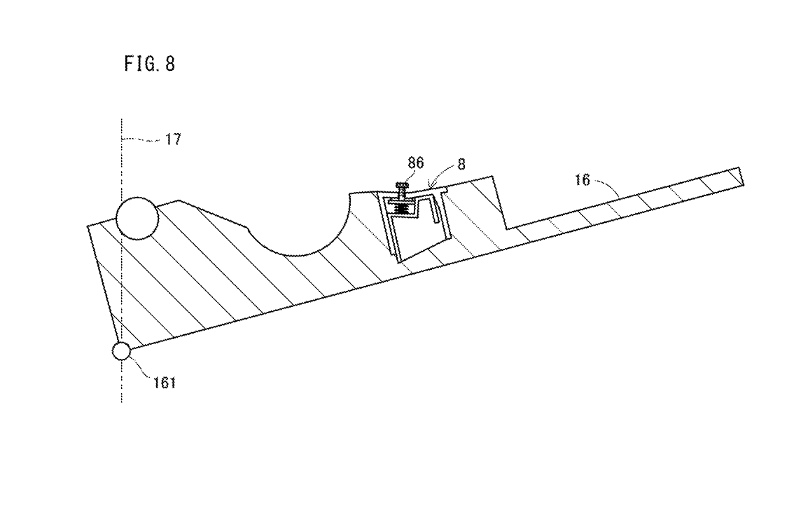

The conveyance path 7 is formed between a transfer position 50 and the fixing device 6, wherein the transfer position 50 is a position where the toner image carried by the intermediate transfer belt 3 is transferred to the sheet S. The conveyance path 7 includes a guide surface 70 configured to guide the sheet S from the transfer position 50 to the fixing device 6. A part of the guide surface 70 is defined by a guide member 81 of the electricity removing device 8 described below. In addition, in the conveyance path 7, a portion on the side of the fixing device 6 (a downstream-side portion) is positioned more on the right than a portion on the side of the transfer position 50 (an upstream-side portion), and the upstream-side portion is relatively larger than the downstream-side portion in size in a direction perpendicular to the conveyance path 7. Accordingly, at least at the part of the guide surface 70 defined by the guide member 81, the distance between the sheet S and the guide surface 70 becomes smaller toward the downstream (see FIG. 6 and FIG. 7).

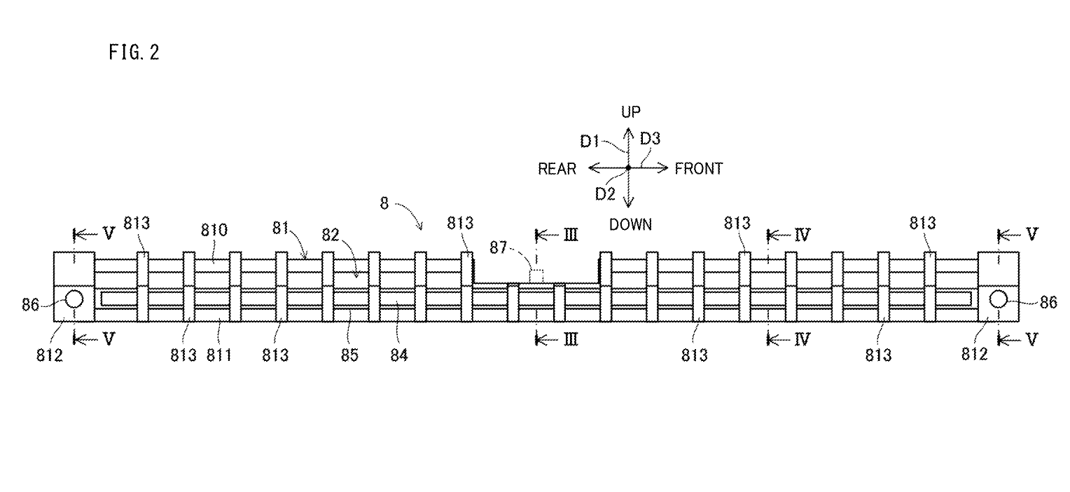

The electricity removing device 8 is fixed to the cover member 16, and moves together with the cover member 16. As shown in FIG. 2 to FIG. 7, the electricity removing device 8 includes the guide member 81, a support member 82, coil springs 83 (an example of the elastic member of the present disclosure), an electricity removing sheet 84 (an example of the conductive member of the present disclosure), a base sheet 85, screws 86 (an example of the operation member of the present disclosure), and the distance measuring sensor 87.

The guide member 81 is elongated in the depth direction D3, and constitutes a part of the guide surface 70 (see FIG. 1). The guide member 81 is formed from an insulating material such as insulating resin. In a case where the guide member 81 is formed from insulating resin, the whole guide member 81 can be formed collectively by resin molding. The guide member 81 includes an upper wall portion 810, a bottom wall portion 811, two first bridge portions 812, and a plurality of second bridge portions 813.

The upper wall portion 810 and the bottom wall portion 811 are each formed in the shape of a plate that is elongated in the front-rear direction D3, and are formed in parallel at an interval in the up-down direction D1.

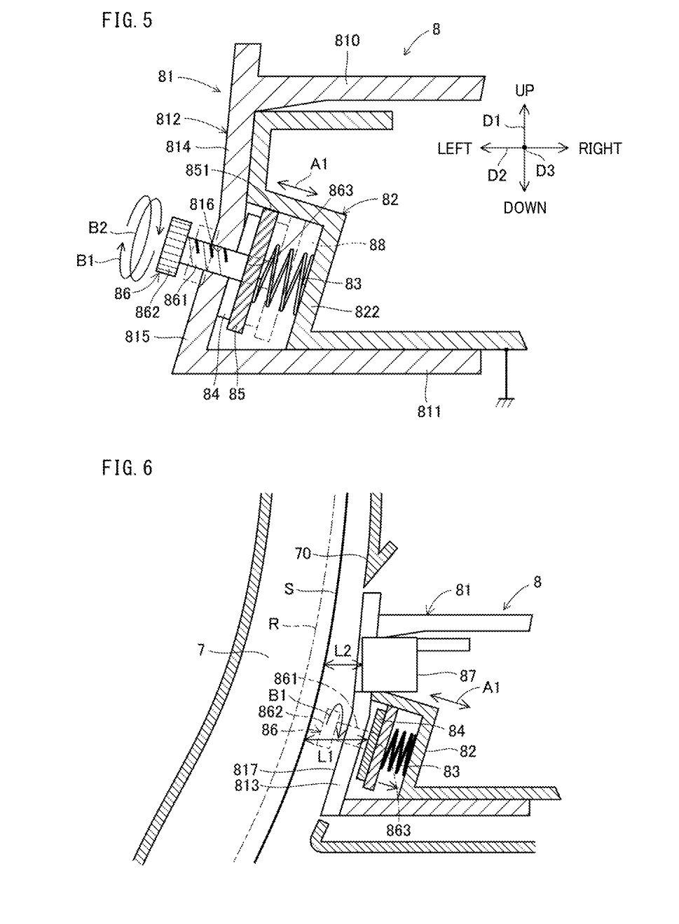

As shown in FIG. 2, the two first bridge portions 812 are formed to extend approximately along the up-down direction D1 and are arranged in parallel at an interval in the front-rear direction D3. The first bridge portions 812 connect to the upper wall portion 810 and the bottom wall portion 811 at opposite ends thereof in the front-rear direction D3. As shown in FIG. 5, each of the first bridge portions 812 includes an upper-half portion 814 and a lower-half portion 815 that are inclined rightward with respect to the up-down direction D1. The lower-half portion 815 is larger than the upper-half portion 814 in inclination angle with respect to the up-down direction D1. In addition, each of the first bridge portions 812 has a through hole 816 (an example of the first through hole of the present disclosure) that pierces through in the thickness direction of the electricity removing sheet 84. The positions of the through holes 816 correspond to opposite end portions of the base sheet 85 in the front-rear direction D3, wherein the base sheet 85 is described below. In addition, the through holes 816 have spiral grooves on their inner surfaces and function as female screws that are to be engaged with the screws 86.

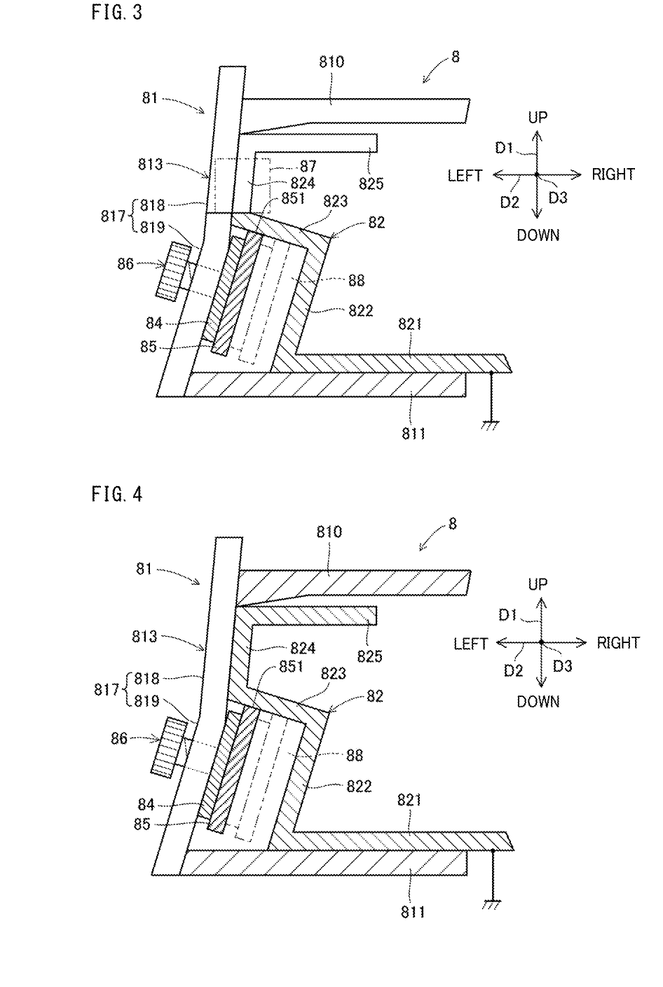

As shown in FIG. 2, the plurality of second bridge portions 813 are formed to extend approximately along the up-down direction D1 and are arranged between the two first bridge portions 812 at intervals in the front-rear direction D3. As shown in FIG. 3 and FIG. 4, each of the second bridge portions 813 has a bent surface 817 on the left side thereof. The bent surface 817 constitutes a part of the guide surface 70 (see FIG. 1), and includes an upper flat surface 818 and a lower flat surface 819. The upper flat surface 818 and the lower flat surface 819 are inclined rightward with respect to the up-down direction D1. The lower flat surface 819 is larger than the upper flat surface 818 in inclination angle with respect to the up-down direction D1.

As shown in FIG. 5, the support member 82 supports the electricity removing sheet 84 via the coil spring 83 and the base sheet 85. As shown in FIG. 3 and FIG. 4, the support member 82 is, in a state of being enclosed in the guide member 81, fixed to the guide member 81. The support member 82 forms a storage space 88 between the support member 82 itself and the second bridge portions 813 of the guide member 81, wherein the storage space 88 allows for movement of the electricity removing sheet 84. The support member 82 is formed by bending a metal such as stainless steel into a crank shape, and is conductive.

The support member 82 includes a first horizontal portion 821, a first standing portion 822, an intermediate portion 823, a second standing portion 824, and a second horizontal portion 825. The first horizontal portion 821 is connected to the bottom wall portion 811 of the guide member 81, and is grounded. The first standing portion 822 supports the coil spring 83, and extends from the first horizontal portion 821 approximately upward. The first standing portion 822 faces the plurality of second bridge portions 813 of the guide member 81, and contributes to the formation of the storage space 88. The intermediate portion 823 extends from the first standing portion 822 approximately leftward, and contributes to the formation of the storage space 88. The second standing portion 824 is connected to the plurality of second bridge portions 813 of the guide member 81, and extends from the intermediate portion 823 approximately upward. The second horizontal portion 825 extends reaward from the second standing portion 824.

As shown in FIG. 5, each of the coil springs 83 is arranged between the electricity removing sheet 84 and the support member 82 in the storage space 88, and biases the electricity removing sheet 84 in the thickness direction of the electricity removing sheet 84 toward the guide surface 70 (see FIG. 1). In one of the two coil springs 83, one end is in contact with one of opposite end portions of the base sheet 85 in the longitudinal direction thereof (in the front-rear direction D3), and the other end of the coil spring 83 is in contact with one of opposite end portions of the first standing portion 822 of the support member 82 in the front-rear direction D3. In addition, the coil spring 83 is disposed on the same axis as the corresponding screw 86, and as the screw 86 advances or retreats, the coil spring 83 moves in the thickness direction of the electricity removing sheet 84. The coil springs 83 may be formed from a conductive material or an insulating material. However, from the vewpoint of efficiently grounding the charges removed by the electricity removing sheet 84, the coil springs 83 are preferably formed from a conductive material. It is noted that instead of the coil springs 83, spring-like elastice members such as plate springs or disc springs, or rubber-like elastic members formed from a resin material having rubber elasticity may be used.

The electricity removing sheet 84 removes transfer charges from the sheet S guided by the guide surface 70 (see FIG. 1). As shown in FIG. 3 to FIG. 5, the electricity removing sheet 84 is disposed in parallel to the lower-half portions 815 of the first bridge portions 812 and the lower flat surfaces 819 of the second bridge portions 813 in the guide member 81, and as the screws 86 are operated, the electricity removing sheet 84 moves in the thickness direction of the electricity removing sheet 84. Here, a direction perpendicular to the lower-half portion 815 and the lower flat surface 819 corresponds to the first direction that intersects the guide surface 70 of the present disclosure. In addition, the direction perpendicular to the lower-half portion 815 and the lower flat surface 819 matches the thickness direction of the electricity removing sheet 84. That is, the movement direction of the electricity removing sheet 84 matches the first direction of the present disclosure. Similarly, the piercing direction of the through hole 816 in the first bridge portions 812 matches the first direction of the present disclosure. Hereinafter, the direction perpendicular to the lower-half portion 815 and the lower flat surface 819 is referred to as a “first direction A1”.

The electricity removing sheet 84 is formed from a conductive material such as conductive resin or metal. In a case where the electricity removing sheet 84 is formed from a conductive resin, the electricity removing sheet 84 is formed from, for example, conductive fiber. For example, the electricity removing sheet 84 is formed from conductive nonwoven fabric. In addition, the electricity removing sheet 84 may be woven fabric or woven fabric of conductive fiber. On the other hand, in a case where the electricity removing sheet 84 is formed from a metal, the electricity removing sheet 84 may be formed from, for example, a metal foil, a metal sheet, a metal plate, or a metal mesh.

The base sheet 85 is a member to which the electricity removing sheet 84 is adhered. As shown in FIG. 2, in a plan view, the base sheet 85 is formed in the shape of a strip that is larger than the electricity removing sheet 84. The base sheet 85 has a bending strength that is strong enough to prevent it from being deflected even if biasing forces from the coil springs 83 act on the opposite end portions thereof (see FIG. 5). As a result, adhered to the base sheet 85, the electricity removing sheet 84 is prevented from being deflected, and its horizontality is secured. In addition, as shown in FIG. 3 to FIG. 5, the base sheet 85 is formed from a metal or conductive resin so as to have conductivity, and a side surface 851 facing up is in contact with the support member 82. As a result, the charges removed by the electricity removing sheet 84 are grounded via the base sheet 85 and the support member 82.

It is noted that in a case where the coil springs 83 are formed from a conductive material, the coil springs 83 can be used to move the charges from the base sheet 85 to the support member 82, and in that case, the side surface 851 of the base sheet 85 needs not necessarily be in contact with the support member 82. In addition, in a case where the conductive member such as the electricity removing sheet 84 has sufficient bending strength, the base sheet 85 may be omitted. In addition, in a case where the electricity removing sheet 84 is formed from a conductive fabric whose surface is electron conjugated polymer, the electricity removing sheet 84 produces a self-discharge effect, and in that case, the base sheet 85 may be formed from an insulating resin such as polyethylene terephthalate.

As shown in FIG. 5 to FIG. 7, the screws 86 are operated so as to change the relative position of the electricity removing sheet 84 with respect to the guide surface 70, and adjust a distance L1 of the electricity removing sheet 84 from the sheet S guided by the guide surface 70. Each of the screws 86 includes a screw portion 861 and a head portion 862. The screw portion 861 is screwed with the through hole 816 of the guide member 81, and an end surface 863 presses an end portion of the base sheet 85 in the front-rear direction D3. When the head portion 862 is rotated in a direction indicated by the arrow B1 or the arrow B2 in the drawing, the screw 86 moves along the first direction A1. With this operation, together with the base sheet 85, the electricity removing sheet 84 moves in the first direction A1 by the same distance as the screw 86. At this time, the coil spring 83 is expanded or contracted in the first direction A1 as the screw 86 moves with respect to the guide member 81 in the first direction A1 in the through hole 816.

It is noted that a member other than the screws 86 may be used as the operation member of the present disclosure. For example, the operation member is not limited to a particular shape as far as it can be held in the through hole 816 of the guide member 81, and it can advance and retreat with respect to the guide member 81 in the first direction A1. In addition, the screws 86 may be formed from a conductive material, but is preferably formed from an insulating material such as insulating resin. The screws 86 formed from an insulating material prevent the sheet S from being attracted by the screws 86.

As shown in FIG. 6 and FIG. 7, the distance measuring sensor 87 measures a distance L2 between the sensor itself and the sheet S that moves along the conveyance path 7. The distance measuring sensor 87 is fixed to the guide member 81. It is noted that a known distance measuring sensor such as an infrared distance measuring sensor or an ultrasonic distance measuring sensor may be used as the distance measuring sensor 87.

As described above, the control portion 15 shown in FIG. 1 determines whether or not a conveyance route of the sheet S moving along the conveyance path 7 is shifted from the target conveyance route R (see FIG. 6 and FIG. 7), based on an output (distance L2) from the distance measuring sensor 87. Upon determining that the conveyance route of the sheet S moving along the conveyance path 7 is shifted from the target conveyance route R, the control portion 15 displays an error on the display portion 142 of the operation/display portion 14.

Meanwhile, in the image forming apparatus 10 in which the electricity removing device 8 is disposed at the conveyance path 7 between the secondary transfer roller 5 and the fixing device 6, the conveyance route of the sheet S moving along the conveyance path 7 may be shifted from the target conveyance route R due to the dimensional tolerance and the assembling tolerance of the secondary transfer roller 5 or the like. Such a shift of conveyance route may occur after the image forming apparatus 10 starts to be used. When, as shown in FIG. 6, the conveyance route of the sheet S is shifted from the target conveyance route R toward the electricity removing device 8, transfer charges of the sheet S may be excessively removed, or toner on the sheet S may be scattered before the sheet S reaches the fixing device 6. On the other hand, as shown in FIG. 7, when the conveyance route of the sheet S is shifted from the target conveyance route R in a direction away from the electricity removing device 8, transfer charges may not be removed from the sheet S, and a malfunction such as a conveyance failure of the sheet S or generation of wrinkles may occur.

In contrast, according to the image forming apparatus 10 of the present disclosure, it is possible to operate the screws 86 to change the relative position of the electricity removing sheet 84 with respect to the guide surface 70 and to adjust the distance of the electricity removing sheet 84 from the sheet S guided by the guide surface 70. For example, as shown in FIG. 5 and FIG. 6, when the screws 86 are rotated in the direction indicated by the arrow B1, the electricity removing sheet 84, together with the base sheet 85, moves along the first direction A1 approaching the guide surface 70 (see FIG. 1). On the other hand, as shown in FIG. 5 and FIG. 7, when the screws 86 are rotated in the direction indicated by the arrow B2, the electricity removing sheet 84, together with the base sheet 85, moves along the first direction A1 away from the bent surface 817. In this way, according to the image forming apparatus 10, it is possible to cause the electricity removing sheet 84 to move along the first direction A1 to approach or separate from the guide surface 70, by rotating the screws 86 in the direction indicated by the arrow B1 or B2. Accordingly, in the image forming apparatus 10, even when the conveyance route of the sheet S moving along the conveyance path 7 is shifted from the target conveyance route R, it is possible to adjust the distance between the electricity removing sheet 84 and the sheet S moving along the conveyance path 7, by operating the screws 86. As a result, in the image forming apparatus 10, it is possible to maintain a state where transfer charges can be removed appropriately from the sheet S, by a simple operation of operating the screws 86 of the electricity removing device 8. Accordingly, in the image forming apparatus 10, the electricity removing sheet 84 can be set at an appropriate position by operating the screws 86 in advance in the phase before the shipment of the product, and prevent a malfunction, such as an image formation failure, a conveyance failure of the sheet S, or generation of wrinkles, from occurring even when the conveyance route of the sheet S moving along the conveyance path 7 is shifted from the target conveyance route R.

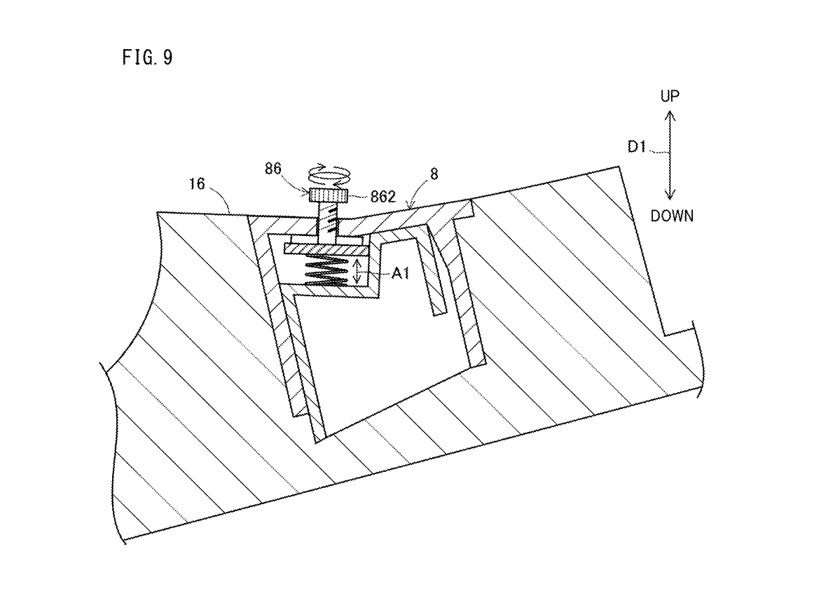

As shown in FIG. 1, the cover member 16 is configured to close an opening 171 formed in an apparatus main body 17. It is noted that FIG. 1 shows a state where the opening 171 is closed by the cover member 16. Here, the apparatus main body 17 constitutes a portion of the image forming apparatus 10 except for the cover member 16. The cover member 16 is configured to pivot between a first attitude and a second attitude about a rotation shaft 161 that extends along the front-rear direction D3, wherein the cover member 16 at the first attitude represened by by the solid line in FIG. 1) forms the conveyance path 7 by closing the opening 171, and the cover member 16 at the second attitude (represented by by the imaginary line in FIG. 1) opens the opening 171. As shown in FIG. 1 and FIG. 8, when the cover member 16 is at the second attitude, the conveyance path 7 is opened and the electricity removing device 8 is exposed to outside of the apparatus main body 17. In addition, as shown in FIG. 9, the cover member 16 is restricted from pivoting by a stopper (not shown) in a state where the head portions 862 of the screws 86 are exposed upward. In this way, since the electricity removing device 8 is exposed when the cover member 16 is at the second attitude, it is possible to easily adjust the position of the electricity removing sheet 84 in the electricity removing device 8. In particular, when the pivoting angle of the cover member 16 is restricted such that the head portions 862 of the screws 86 of the electricity removing device 8 are exposed upward, it becomes easy to operate the screws 86.

Furthermore, the display portion 142 of the operation/display portion 14 displays an error when the conveyance route of the sheet S moving along the conveyance path 7 is shifted from the target conveyance route R. Upon viewing the displayed error, the user recognizes that the conveyance route of the sheet S is shifted from the target conveyance route R. In that case, the user himself/herself may operate the screws 86 of the electricity removing device 8 or may request a serviceperson to do it so as to prevent a malfunction from occurring due to the shift of the conveyance route of the sheet S from the target conveyance route R.

### Second Embodiment

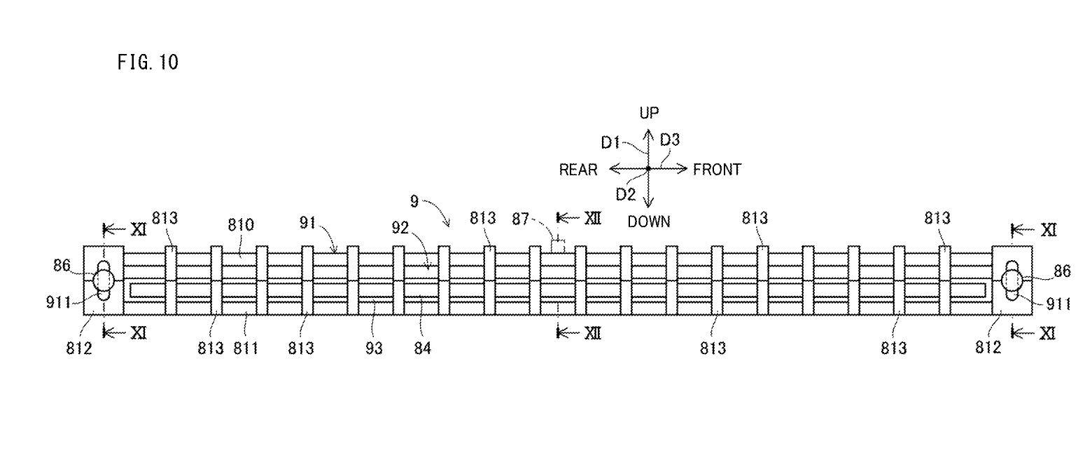

Next, a description is given of an image forming apparatus according to a second embodiment of the present disclosure with reference to FIG. 10 to FIG. 13. It is noted that in FIG. 10 to FIG. 13, the same components as those of the first embodiment are assigned the same reference signs, and description thereof is omitted.

According to the image forming apparatus of the present embodiment, a configuration for moving an electricity removing device 9 is different from the electricity removing device 8 of the first embodiment.

As shown in FIG. 10 to FIG. 12, the electricity removing device 9 includes a guide member 91, a support member 92, the electricity removing sheet 84, a base sheet 93, the screws 86, and the distance measuring sensor 87, wherein the guide member 91 constitutes a part of the guide surface 70 (see FIG. 1).

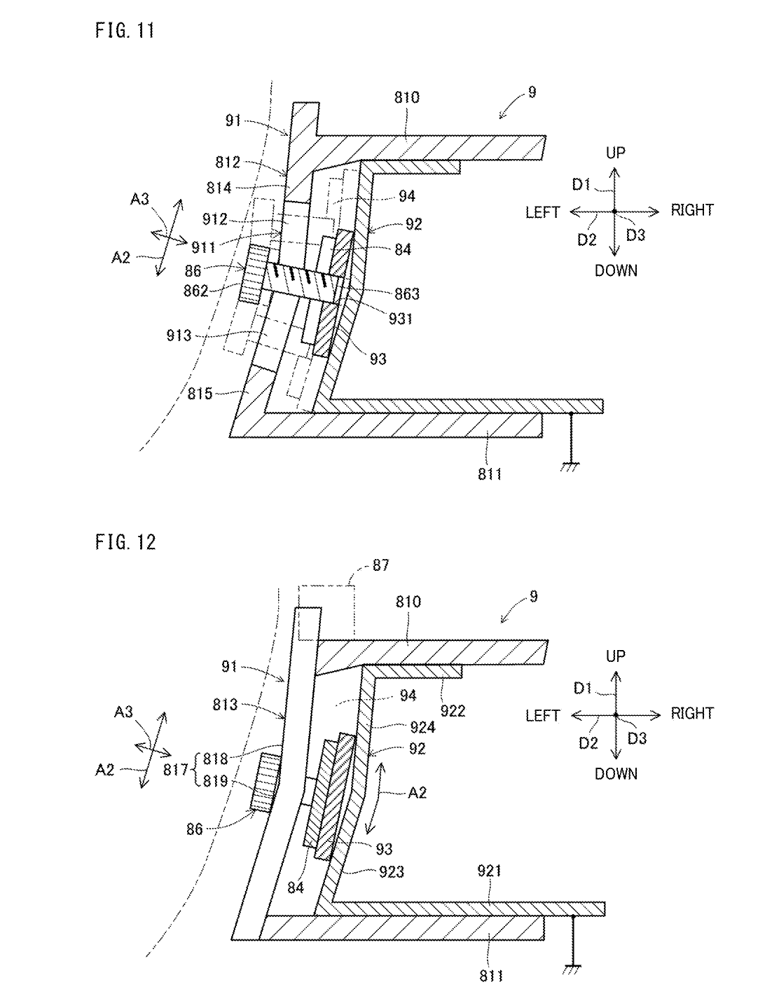

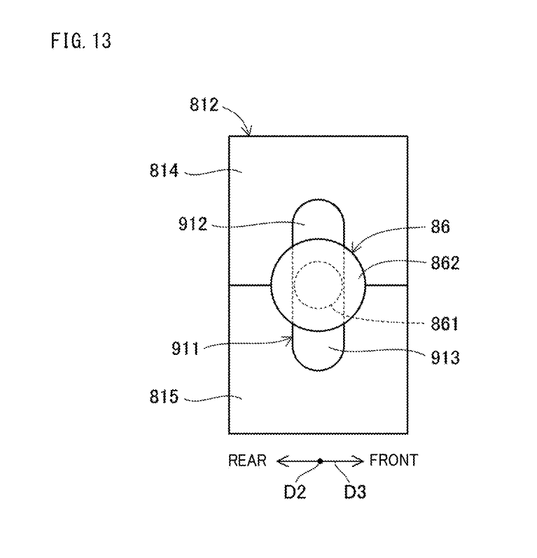

As shown in FIG. 11 and FIG. 13, the guide member 91 includes through holes 911 (an example of the second through hole of the present disclosure) formed in the first bridge portions 812. The through holes 911 extend in a second direction A2 that includes a conveyance direction of the sheet S in the conveyance path 7 (see FIG. 1) and a direction opposite to the conveyance direction. In addition, the through holes 911 pierce through in a third direction A3 that intersects the second direction A2. Each of the through holes 911 includes an upper through hole portion 912 formed in the upper-half portion 814 of the first bridge portions 812, and a lower through hole portion 913 formed in the lower-half portion 815 of the first bridge portions 812. Here, the size of the through holes 911 in the front-rear direction D3 is set to be equal to or slightly larger than the diameter of the screw portions 861 of the screws 86, and smaller than the diameter of the head portions 862 of the screws 86. The size of the upper through hole portion 912 and the lower through hole portion 913 of the through holes 911 in the second direction A2 is set to be larger than the diameter of the screw portions 861. In addition, no spiral groove is formed on the inner surfaces of the through holes 911, and the inner surfaces of the through holes 911 are plane.

As shown in FIG. 11, the support member 92 forms a storage space 94 between the support member 92 itself and the guide member 91, wherein the storage space 94 allows for movement of the electricity removing sheet 84 along the second direction A2. In the support member 92, a first horizontal portion 921 and a second horizontal portion 922 are connected to each other by a first standing portion 923 and a second standing portion 924. The first standing portion 923 extends from the first horizontal portion 921 upward, and is parallel to the lower flat surface 819 of the second bridge portions 813 of the guide member 91. The second standing portion 924 extends from the second horizontal portion 922 downward, and is parallel to the upper flat surface 818 of the second bridge portions 813 of the guide member 91.

The base sheet 93 includes through holes 931 respectively at opposite end portions thereof in the front-rear direction D3. The through holes 931 have, on their inner surfaces, spiral grooves (not shown) that are to be engaged with the screws 86.

The screws 86 are engaged with the through holes 931 of the base sheet 93, and can be moved in the third direction by being rotated with respect to the base sheet 93. When the screws 86 are rotated and moved along the third direction approaching the support member 92, the end surfaces 863 of the screw portions 861 of the screws 86 are pressed against the support member 92. In this state, the head portions 862 of the screws 86 are engaged with the peripheral portions of the through holes 911, and the positions of the screws 86 with respect to the through holes 911 are fixed. This allows the positions of the base sheet 93 and the electricity removing sheet 84 adhered to the base sheet 93 to be fixed in the storage space 94. On the other hand, when the screws 86 are operated to be moved away from the support member 92 along the third direction, the end surface 863 is separated from the support member 92. In this state, the head portions 862 of the screws 86 are not engaged with the peripheral portions of the through holes 911, and the screws 86 can move in the through holes 911 along the second direction A2 with respect to the guide member 91. In addition, since the screws 86 are engaged with the through holes 931 of the base sheet 93, when the screws 86 are operated to be moved in the through holes 911 in the second direction A2, the electricity removing sheet 84, together with the base sheet 93, is moved in the storage space 94 in the second direction A2.

In the above-described electricity removing device 9, it is possible to change the relative position of the electricity removing sheet 84 in the storage space 94 in the second direction A2. On the other hand, as described above, the distance between the guide surface 70 and the sheet S passing through the part of the guide surface 70 defined by the guide member 91, becomes smaller toward the downstream side. As a result, it is possible to adjust the distance between the electricity removing sheet 84 and the sheet S by changing the relative position of the electricity removing sheet 84 in the storage space 94 in the second direction A2. Accordingly, in the image forming apparatus 10, since it is possible to maintain the state where transfer charges can be removed from the sheet S appropriately by a simple work of operating the screws 86 of the electricity removing device 9, even when the conveyance route of the sheet S moving along the conveyance path 7 is shifted from the target conveyance route R, it is possible to prevent a malfunction, such as an image formation failure, a conveyance failure of the sheet S, or generation of wrinkles, from occurring.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
an image carrier configured to carry a toner image;
a transfer portion configured to transfer the toner image carried by the image carrier to a sheet;
a fixing portion configured to fix, to the sheet, the toner image transferred to the sheet;
a conveyance path having a guide surface configured to guide the sheet with the toner image transferred thereto, to the fixing portion; and
an electricity removing portion including:
a conductive member configured to remove charges from the sheet guided by the guide surface; and
an operation member configured to change a relative position of the conductive member with respect to the guide surface and adjust a distance of the conductive member with respect to the sheet guided by the guide surface.

2. The image forming apparatus according to claim 1, wherein
when the operation member is operated, the conductive member moves in a first direction that intersects the guide surface.

3. The image forming apparatus according to claim 2, wherein
the electricity removing portion further includes:
a guide member constituting a part of the guide surface and having a first through hole that pierces through in the first direction;
a support member forming a storage space between the support member itself and the guide member, the storage space allowing for movement of the conductive member; and
an elastic member disposed between the conductive member and the support member in the storage space, and biasing the conductive member toward the guide surface, and
the operation member is moved in the first through hole in the first direction so as to cause the elastic member to advance or retreat.

4. The image forming apparatus according to claim 1, wherein
when the operation member is operated, the conductive member moves in a second direction that includes a conveyance direction of the sheet in the conveyance path and a direction opposite to the conveyance direction.

5. The image forming apparatus according to claim 4, wherein
the electricity removing portion further includes:
a guide member constituting a part of the guide surface and having a second through hole that extends along the second direction and pierces through in a third direction that intersects the second direction; and
a support member forming a storage space between the support member itself and the guide member, the storage space allowing for a movement of the conductive member,
the operation member is moved in the second through hole in the second direction, and
when the operation member is moved in the second direction, the conductive member is moved in the second direction.

6. The image forming apparatus according to claim 1, further comprising:
a cover member configured to close an opening formed in an apparatus main body, wherein
the cover member is configured to pivot between a first attitude and a second attitude, wherein the cover member at the first attitude forms the conveyance path by closing the opening, and the cover member at the second attitude opens the opening, and
the electricity removing portion is fixed to the cover member, and when the cover member is at the second attitude, the electricity removing portion is exposed to outside of the apparatus main body.

7. The image forming apparatus according to claim 1, wherein
the conductive member is formed from conductive fiber.

8. The image forming apparatus according to claim 7, wherein
the conductive member is conductive nonwoven fabric.

9. The image forming apparatus according to claim 1, wherein
the operation member is a screw.
